(19) United States
(12) Patent Application Publication
(10) Pub. No.: US 2014/0204759 A1
(43) Pub. Date: Jul. 24, 2014

(54) Load Balanced Routing for Low Power and Lossy Networks

(71) Applicant: MITSUBISHI ELECTRIC RESEARCH LABORATORIES, INC, (US)

(72) Inventors: Jianlin Guo, Newton, MA (US); Xinxin Liu, Gainesville, FL (US); Ghulam Bhatti, Mansfield, MA (US); Philip Orlik, Cambridge, MA (US); Kieran Parsons, Cambridge, MA (US)

(73) Assignee: MITSUBISHI ELECTRIC RESEARCH LABORATORIES, INC., Cambridge, MA (US)

(21) Appl. No.: 13/746,173

(22) Filed: Jan. 21, 2013

(51) Int. Cl. H04W 28/08; H04W 28/02

(52) U.S. Cl. CPC H04W 28/08; H04W 28/0236
USPC 370/236

(57) ABSTRACT

A node includes a receiver for receiving a first packet from a first node at a first time and a second packet from a second node at a second time, a processor for determining the first time and the second time and for comparing the first time with the second time to produce a ratio of workloads of the first node and the second node, and a transmitter for transmitting packets to the first and the second nodes based on the ratio.

### FIELD OF THE INVENTION

This invention relates generally to routing packets in wireless networks, and particularly to load balanced routing for low power and lossy networks.

### BACKGROUND OF THE INVENTION

In low-power and lossy networks (LLNs), nodes and communication links are constrained. Nodes in the LLN typically operate with resource constrains on processing power, memory, power consumption, lifetime, rate of activity, and physical size. The communication links between the nodes can be characterized by high loss rate, low data rate, instability, low transmission power, and short transmission range. There can be from a few dozen up to thousands of nodes within a practical LLN. Examples of LLN include a smart meter network, and a wireless sensor network for building monitoring.

In contrast with other networks, the LLN can also have constrained traffic pattern. Multipoint-to-point, e.g., from nodes inside the LLN towards a central control or data concentrator node, traffic is dominant. The point-to-multipoint, e.g., from a central control point to a subset of nodes inside the LLN, traffic is less common. The point-to-point, e.g., between nodes in the LLN, traffic is rare. The control node in LLNs usually acts as data sink and collects data from all other nodes in LLNs.

LLN applications typically require uneven node deployment and a high packet delivery rate, which can result in uneven workload of the nodes, referred as load unbalanced routing. Load unbalanced routing can result in packet loss by LLN nodes due to small buffer sizes. Also, routing overhead can increase the workload of LLN nodes, and therefore can result in extra packet loss. Unfortunately, the conventional routing methods are not designed for workload balancing and routing overhead minimization suitable for usage in LLN. However, load balanced routing in LLN can increase bandwidth, improve reliability, reduce interference and transmission delay.

For example, the internet engineering task force (IETF) has developed an IPv6 routing protocol for low-power and lossy networks (RPL). Even though RPL is a multi-path routing protocol, routes are discovered based on a predefined metric, such as hop count or expected transmission count. After the routes are discovered, a node transmits all packets to a single node, called a preferred parent node that is one “hop” away. As a result, the preferred parent node might have a larger workload than other nodes. Packets can be data, control or management packets.

FIG. 1 shows an example of unbalanced routing in a smart meter network, including a concentrator node C 110, and a set of smart meter nodes (M). The smart meter nodes, e.g., a node 130, transmit their metering data packets along certain routes, e.g., a route 140, to the concentrator C. The smart meter network can include a subset of smart meter nodes, e.g., a set 120, that can be densely deployed.

Based on a shortest path routing protocol, all these smart meter nodes transmit their metering data packets to concentrator C via node M1 125. Such transmission scheme can overload the node 125 when compared with other nodes, such as nodes M4 150 and M5 155.

Accordingly, it is desired to provide load balanced routing suitable for LLNs. Several conventional routing methods are developed for load balancing. However, those conventional routing methods are not optimal for LLNs.

For example, U.S. Pat. No. 7,936,704 describes a method of configuring the topology of a communication network as a forest structure comprising trees and subtrees. However, that method is a single path routing method, because after discovery of the route, all packets have to be sent to a selected next hop node. Also, the method increases communication overhead, which must be minimized in LLNs.

U.S. Pat. No. 7,633,940 BI describes an adaptive load-balanced routing method for interconnection networks. Approximate global congestion is sensed as a function of channel queues, with routing methods selected in accordance with the sensed congestion. However, that usage of the channel queue can result in packet loss by a LLN node due to limited storage of the nodes.

U.S. Pat. No. 7,366,100 describes an architecture that allows multipath packets to be distributed over multiple paths using a hash function. However, that method is not a load balanced routing method, but a multipath routing method.

U.S. Publication 2008/0112326 describes a method for load-balancing routes in multi-hop ad-hoc wireless networks. In accordance with that method, when a node receives a routing-protocol message, the node waits before retransmitting the message, where the amount of time that the node waits is based on a value of a load metric at the node, which is independent of metrics of any other nodes in the network. As a result, a node that has a larger load will wait longer to transmit a routing-protocol message, and consequently, the node is less likely to be selected for inclusion in the new route. That method also establishes a single parent node route.

Load balanced routing provides numerous benefits to LLN, such as improving network throughput, increasing energy efficiency, prolonging network operating duration, especially for battery-powered networks, and reducing communication overhead. Therefore, load balancing under the non-uniform node distribution is critical. It is desirable to develop a load balanced routing method for LLNs to deliver data packets and control packets reliably minimizing packet loss or shortening network operability.

### SUMMARY OF THE INVENTION

Various embodiments of the invention are based on a general realization that load balancing can be improved by transmitting packets from a node to multiple neighboring nodes, as contrasted with transmission to a single parent node. Moreover, if the allocation of the packets transmitted to the neighboring nodes is based on current workloads of those neighboring nodes, the overall workloads of the neighboring nodes are balanced.

Some embodiments of the invention are based on another realization that for allocating packets according to the workloads of neighboring nodes, sometimes it is not necessary to determine the actual workloads of those nodes, because relative comparison of the workloads can be sufficient for the allocation. For example, packets can be transmitted more often to a neighboring node having a lower workload than packets transmitted to a neighboring node having a higher workload. Specifically, one exemplar embodiment determines a ratio of workloads indicating the relative values of the workloads and allocates transmission of the packets to the neighboring nodes according to that ratio.

Some embodiments determine the ratio of the workloads based on local information collected by the node, e.g., by comparing times of receiving packets from neighboring nodes. The local information collected during an operation of the LLN can include information indicative of transmission itself, as contrasted with global information including content transmitted as part of the packets. Such approach allows for comparison of the workloads without submitting additional information. Examples of the collected information include time of transmission, a number and/or rate of received packets.

Accordingly one embodiment discloses a node including a receiver for receiving a first packet from a first node at a first time and a second packet from a second node at a second time, a processor for comparing the first time with the second time to produce a ratio of workloads of the first node and the second node, and a transmitter for transmitting packets to the first and the second nodes based on the ratio. This embodiment allows allocating transmission of the packets to multiple nodes based on workloads of those nodes to achieve a balanced routing. In some embodiments, the node also includes a timer for delaying transmission of the packets to implicitly indicate the workload to other nodes. In those embodiments, the nodes can influence the allocation of the packets.

For example, to achieve load balanced routing, a node can determine a first node having a workload less than a workload of a second node based on time of receiving packets from the first and the second nodes, and generate a command to transmit a set of data packets to the first and the second nodes, such that more packets from the set are transmitted to the first node than to the second node.

A ratio of the packets transmitted to the first and the second nodes can be determined as a function of the ratio of the workloads. For example, in one embodiment, the processor updates the ratio of the transmitted packets based on quality of links connecting the node with the first node and with the second node. Considering quality of links in determining the ratio can advantageously use the load balancing to reduce the loss rate of the packets during upward transmission.

Some embodiments of invention provides a delay timer calculation method to signal the workload of a node. A node uses a time delay mechanism to signal the workload such that a node with small workload has a shorter time delay in transmitting route discovery packet, and a node with large workload has a longer time delay in transmitting route discovery packet. Timer value can be proportional to workload. In one embodiment, the magnitude of the delay is set such that the route discovery packet transmission backoff delay incurred by lower layers does not affect workload signaling.

A node can record the time of receiving a route discovery packet from each potential parent nodes. An earlier time indicates that route discovery packet transmitter has a smaller workload and a later time indicates that route discovery packet transmitter has a larger workload. Periodic route discovery allows updating the workloads dynamically.

### BRIEF DESCRIPTION OF THE DRAWINGS

FIG. 1 is schematic of a smart meter network with a conventional load unbalanced routing;

FIG. 2A is a block diagram of a method suitable for routing packets by a node in a low-power and lossy network (LLN) according to some embodiments of an invention;

FIG. 2B is a schematic of a structure of the node performing the method of FIG. 2A according to some embodiments of an invention;

FIG. 3 is an example of load balanced routing for smart meter networks of FIG. 1;

FIG. 4A is a schematic of LLN in which some embodiments of the invention can operate;

FIG. 4B is a schematic of routing discovery packet propagation in a LLN;

FIG. 5 is a schematic of a queuing model for relay-based networks;

FIG. 6 is a timing diagram of a relationship between workload and delay period according to some embodiments of an invention;

FIG. 7A is a schematic of a network ready for priority order assignment;

FIG. 7B is a table illustrating an example of priority order assignment according to some embodiments of an invention;

FIG. 8 is an example of parent priority order assignment variation according to some embodiments of an invention;

FIG. 9A is a schematic of routing method for upward transmission according to some embodiments of an invention;

FIG. 9B is a schematic of routing method for parent selection and upward transmission according to some embodiments of an invention;

FIG. 10 is a schematic of routing method for downward transmission according to some embodiments of an invention; and

FIG. 11 is a table illustrating packet loss distribution based on buffer size.

### DETAILED DESCRIPTION OF THE PREFERRED EMBODIMENTS

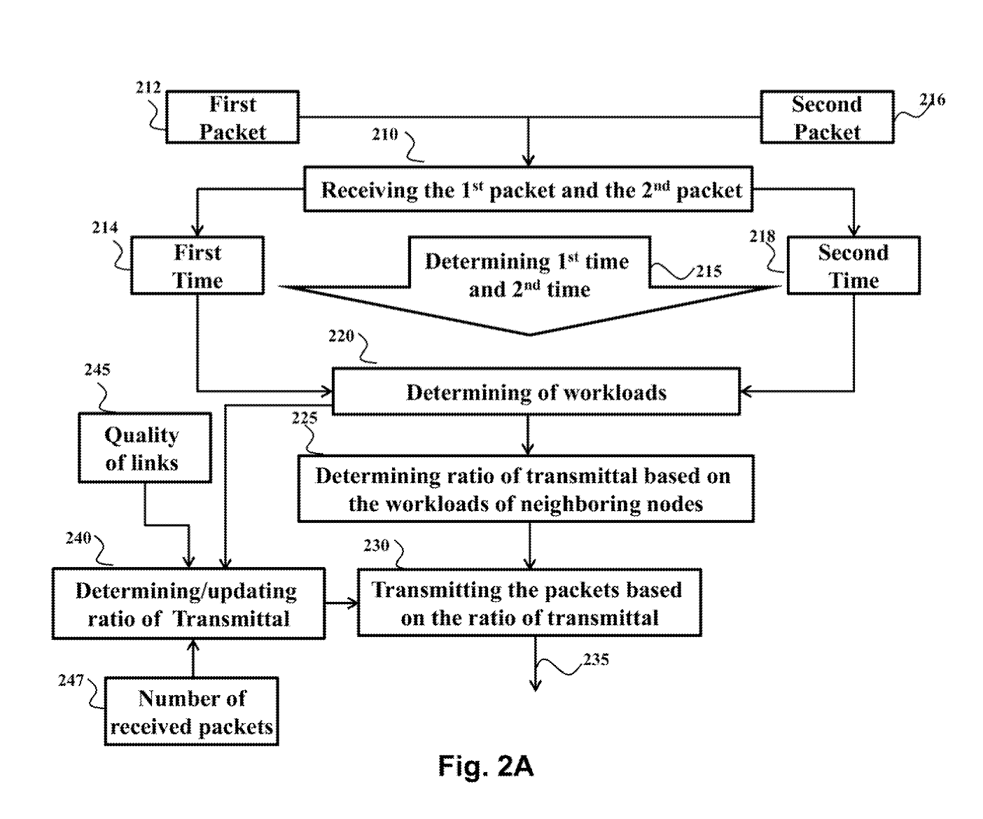

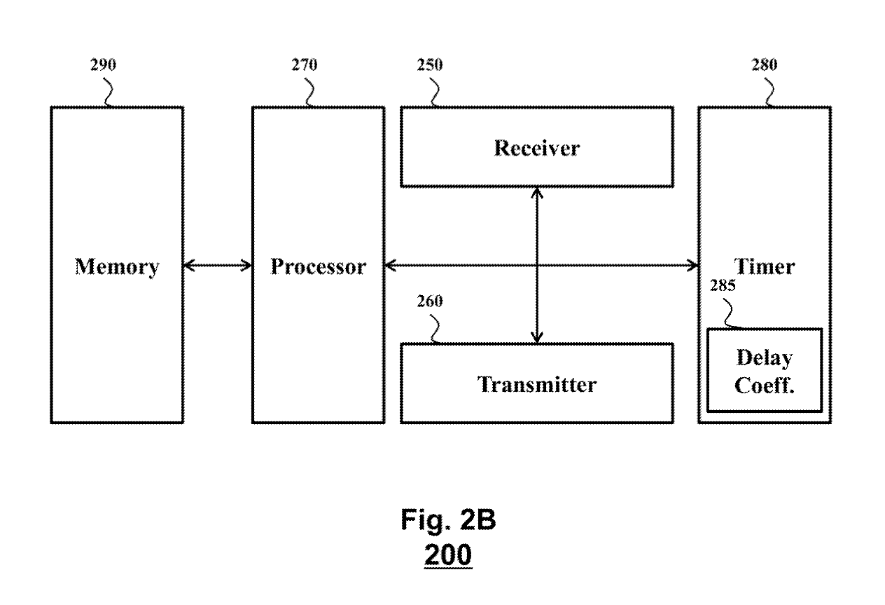

FIG. 2A shows a block diagram of a method for routing packets by a node 200 in a low-power and lossy network (LLN). FIG. 2B shows schematically a structure of the node 200. In various embodiments, the load balancing is achieved by transmitting the packets to the multiple nodes neighboring the node 200, e.g., at a rate proportional to the workloads of those neighboring nodes. Such transmittal allows balancing the load over multiple neighboring nodes, instead of transmitting all packets to a single parent node in an unbalanced manner. Moreover, the allocation of the packets transmitted to the neighboring nodes is based on current workloads of those nodes to balance the overall workload of the neighboring nodes. In various embodiments, the comparison of the workloads is performed without increasing communication overhead of the LLN.

For example, a first packet 212 is received 210 by the node 200 from a first node at a first time 214, and a second packet 216 is received 210 by the node 200 from a second node at a second time 218. The first and the second nodes are not shown on the Figures, but can have structures and functionalities similar to the structure and the functionality of the node 200. The node 200, and the first and the second nodes can form at least a part of the LLN. The first and the second nodes are the neighboring nodes for the node 200, i.e., are within one hop from the node 200.

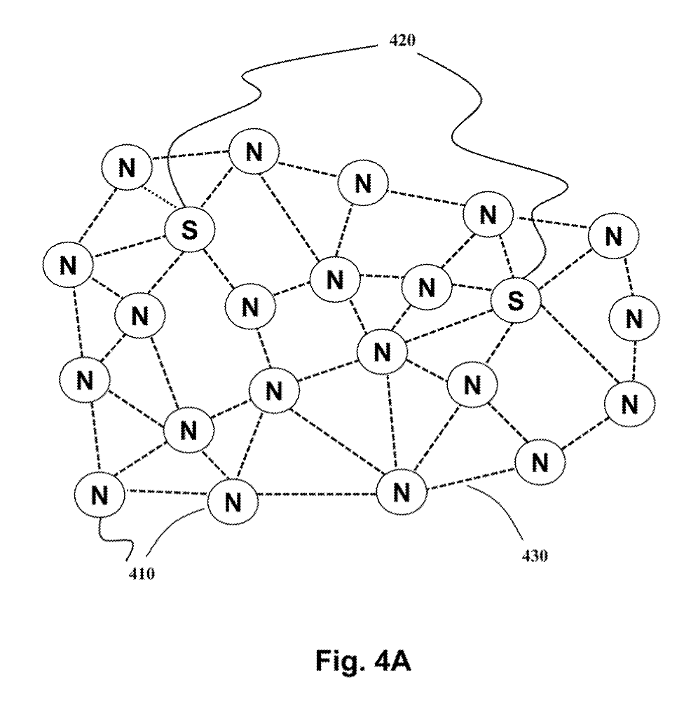

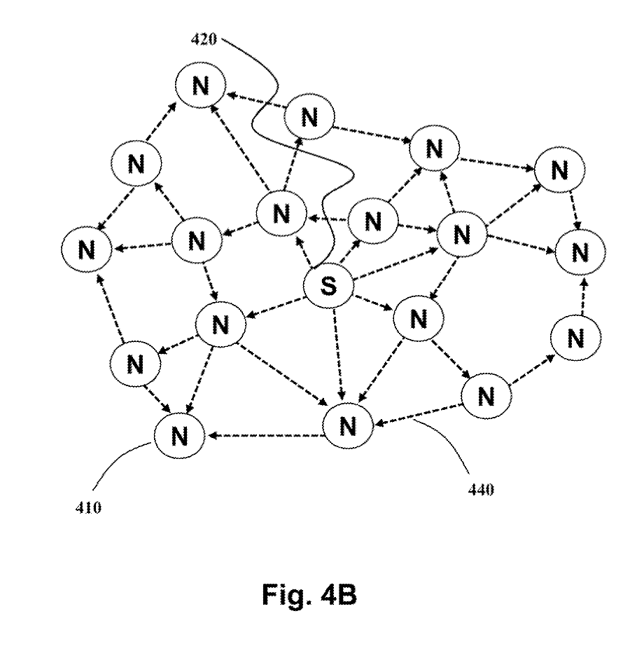

The node 200 includes a receiver 250 for receiving the packets. The node 200 also includes a processor 270 for comparing the workloads of the neighboring nodes. The node 200 also includes a transmitter 260 for transmitting packets to the neighboring nodes. In some embodiments, the first packet and the second packet include a route discovery packet 440 as shown in FIG. 4B, and the transmitted packets include data packets.

If the processor determines that a first node has a workload less than a workload of a second node based on packets received from the first and the second nodes, then the processor generates a command to the transmitter to transmit a set of packets to the first and the second nodes, such that more packets from the set are transmitted to the first node than to the second node. The transmitted packets can include data packets, and control packets.

In some embodiments, the processor determines 215 the first time 214 and the second time 218. The processor then determines 220 the workloads of the first and the second nodes as a function of the first time 214 and the second time 218. Based on the workloads 220, the processor determines 225 the ratio of packets to be transmitted to the first node and the second node. The transmitter transmits 230 packets to the first and the second nodes based on the ratio 225. For example, in one embodiment, the processor determines a number of packets Z₁ for transmitting to the first node according to Z₁=(T₂/(T₁+T₂))*Z, wherein the processor determines a number of packets Z₂ for transmitting to the second node according to Z₂=(T₁/(T₁+T₂))*Z, wherein T₁ is the first time, T₂ is the second time, and Z is a total number of the packets transmitted to the first and the second nodes.

In alternative embodiments, the ratio 235 is updated dynamically. For example, in one embodiment, the processor updates 240 the ratio of the transmitted packets based on workloads 220 and quality of links 245 connecting the node with the first node and with the second node. An example, of the ratio of transmission is given in Equation (8). Considering quality of the links in determining the ratio can advantageously use the load balancing to reduce the loss rate of the packets during upward transmission.

In alternative embodiment, the processor updates 240 the ratio of the transmitted packets based on a number of packets 247 received from the first and the second nodes. For example, in one embodiment, the processor determines a number of packets Z, for transmitting to the first node according to Z, =(R₂/(R₁+R₂))*Z, wherein the processor determines a number of packets Z₂ for transmitting to the second node according to Z₂=(R₁/(R₁+R₂))*Z, wherein R₁ is the number of packets received from the first node, R₂ is the number of packets received from the second node, and Z is a total number of the packets transmitted to the first and the second nodes. This embodiment can further update the ratio of transmission based on statistics collected during the operation of the network without transmitting any additional information. Also, this embodiment can be advantageous during downward packets transmission to multiple child nodes based on workload of the child nodes to achieve load balancing.

In some embodiments, the node also includes a timer 280 for delaying transmission of the packets to implicitly indicate the workload. In those embodiments, the node 200 and the neighboring nodes can influence the allocation of the packets. In some embodiments, workload is determined in a distributed manner such that each node can determine its workload independently. Several criteria can be used to calculate workload. According to one embodiment, the average or total number of packets queued in buffer of a memory 290 of the node within a certain time period indicate the workload of the node.

In some embodiments, the processor multiplies the workload of the node with a delay coefficient 285 to determine a period of the delay. Also, the processor updates the delay coefficient during an operation of the node. The delay coefficient can be selected based on the structure, density and application of the LLN, such that the packets of the node with smaller workloads are received earlier that the packets of the node with heavier workload despite the natural delays in the LLN.

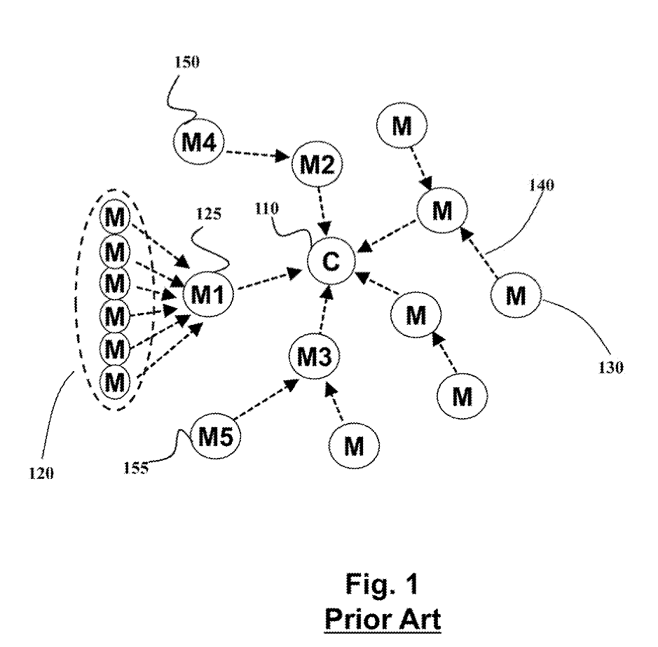

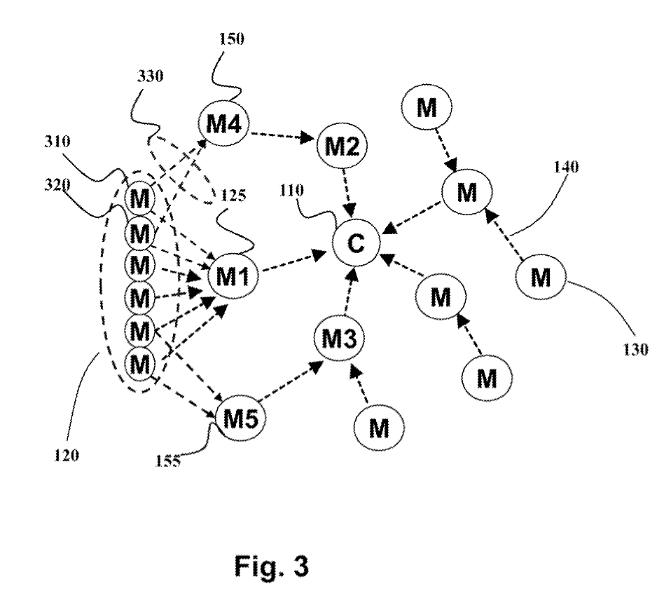

FIG. 3 shows load balanced routing for the smart meter network of FIG. 1. According to some embodiments of the invention, the workload is distributed by smart meters forwarding packets to nodes M4 150, M5 155, and M1 125. For example, some nodes, such as nodes 310 and 320, transmit packets to multiple nodes. Specifically, in this example, the nodes 310 and 320 transmit to the node 125 as before, but also transmit 330 to the node 150. As a result, because the allocation is based on the relative workload of the nodes 125 and 150, the workloads of the nodes 125 and 150 are balanced.

Low-Power and Lossy Network

FIG. 4A shows a schematic of a LLN in which embodiments of the invention can operate. The LLN includes of a set of nodes 410 and a set of sinks 420. The LLN nodes and sinks are organized in a two-tier hierarchy. Each sink is responsible for communicating with a sub-set of nodes. Sinks can transmit control and management packets to other LLN nodes.

All nodes can be data sources. The LLN typically has non-uniform node distribution. Nodes and sinks form a mesh topology and communicate using wireless links 430. To ensure connectivity, nodes are arranged such that each node has a non-empty set of neighboring nodes. Each node in a LLN transmits data through one or multiple hops to one of the data sinks. A node may also need to forward packets received from neighbors towards data sinks.

FIG. 4B shows a schematic of route discovery packet propagation in a LLN in which embodiments of the invention can operate. Transmission of route discovery packet 440 is initiated by a sink node 420. The first hop neighboring nodes of sink node 420 receive the route discovery packet 440, select routes to sink node, update the route discovery packet and transmit the updated route discovery packets. The second hop neighboring nodes of sink node 420 receive the route discovery packets transmitted by the first hop nodes, select routes to sink node, update the route discovery packets and transmit the updated route discovery packets. This process continues until all nodes 410 receive route discovery packets and discovery routes to sink node.

Load Balanced Routing

A size of a buffer in a node in a LLN is relatively small. Therefore, a LLN node can only buffer a relatively small number of packets. When the buffer is full, a LLN node has to ignore subsequent packets or delete already buffered packets. In a multi-hop LLN, most of nodes need to relay packets, especially, nodes near the sinks. Unbalanced routing can cause buffers of the nodes with large workload to fill much faster than the buffers of the nodes with smaller workload.

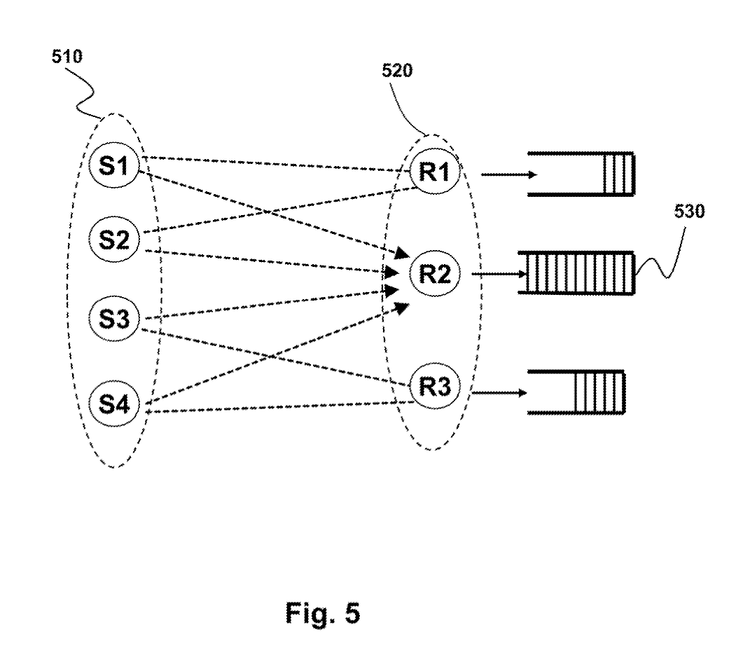

FIG. 5 shows an example of unbalanced routing, in which four source nodes 510 are S1, S2, S3 and S4, and three relay nodes 520 are R1, R2 and R3. All four source nodes forward their packets to relay node R2 instead of distributing packets among the three relay nodes. As a result, R2's buffer is full 530, and R2 starts losing packet.

The packet loss can be caused by an inadequate buffer size. Assume the total number of packets generated by all source nodes follows a Markov process and the processing of packets at a relay node i is also Markov process, the system can be modeled as an M/M/1/qᵢ queue, where qᵢ denotes a buffer size of relay node i. According to finite queue analysis, the packets are lost when the number of arriving packets exceeds the buffer size of the relay node. The probability of packet loss by node i is

$${p}_{i}^{b} = \{ \begin{matrix}\frac{1}{{q}_{i} + 1} & ρ = 1 \\ \frac{{ρ}^{{q}_{i}} ( 1 - ρ )}{1 - {ρ}^{{q}_{i} + 1}} & ρ \neq 1\end{matrix} \qquad ( 1 )$$

Where ρ=λ/μ and λ is the packet arrival rate at node i and μ is a service rate at node i. Based on the equation (1), the number of packet sources has a critical role in determining the ratio of the packet arrival and departure rates. In addition, the buffer size at the relay node significantly affects the packet loss rate. Therefore, the buffer size is an important factor to be considered in balanced routing.

There are many metrics that can be used to evaluate the performance of outing methods. The commonly used metrics are packet delivery rate, end-to-end delay, routing packet overhead, etc. Some embodiments use packet delivery rate as the metric to develop a load balanced routing model.

For a node i in a LLN, denote the packet loss rate caused by channel condition as pᵢ^{c}. Using Equation (1), the probability of successfully relaying a packet to next hop node by node i is

pᵢ^{r}=(1−pᵢ^{b})(1−pᵢ^{c}) (2)

For a node i, the probability of successfully sending its packet to the next hop node is

pᵢ^{s}=(1-pᵢ^{c}) (3)

Therefore, pᵢ^{d}=pᵢ^{r}+pᵢ^{s} is the packet delivery rate at node i.

For each node, there may be multiple nodes that can be used as the next hop nodes. A node decides which workload distribution can result in the maximum packet delivery rate. Denote the set of workload distribution using a distribution matrix as

$$s = [ \begin{matrix}{s}_{11} & … & {s}_{1 n} \\ ⋮ & ⋱ & ⋮ \\ {s}_{n 1} & … & {s}_{n n}\end{matrix} ] \qquad ( 4 )$$

where sᵢⱼ denotes the number of packets forwarded from node i to node j. The optimal workload distribution for overall LLN is given by

\hat{s}=arg max_{sεS}Σ_{iεN}pᵢ^{d} (5)

where S is set of workload distribution matrices and N is set of nodes in LLN.

The optimization process for other performance metrics can be developed similarly.

Load Balanced Routing for LLNs

Usually, given a sink, for any routing method, there are only a small number of non-zero elements in each row of workload distribution matrix given by equation (4). For example, for a single path routing method such as ad hoc on demand vector (AODV), there is only one non-zero element in each row. For a two path routing method, there are at most two non-zero elements in each row. In general, for a multipath routing protocol such as RPL, the number of non-zero elements in a row is less than or equal to the number of next hop candidates of the corresponding node.

In large scale LLNs, it can be impractical to obtain system level optimization as in Equation (5) because of a lack of system level information. A practical approach for routing in large scale LLNs is to let the nodes make decisions in a distributed fashion. Based on load balanced routing model given by equation (5), the embodiments of the invention provide a load balancing method that aims to improve workload balance problem for routing in LLNs and therefore, maximize the packet delivery rate.

To improve the workload balance LLNs, the load balancing of some embodiments has following features:
a. Distributed: Due to the size of the LLNs and the resource limitations with the LLN nodes, it is difficult to obtain global information about communication status of each node. Therefore, a distributed method is preferred.
b. Non-intrusive: Although there are existing solutions for collecting node information to strategically select better routing paths, the periodical information collection and control messages make them unsuitable for LLNs. A better strategy is to detect and signal workload imbalance in a non-intrusive way.
c. Reliability: In order to balance workload among nodes, some data traffic may be relayed through a path with imperfect communication link quality. To maintain reliability, both workload balance and communication link quality need to be considered.

To provide a routing protocol for LLNs, the Internet Engineering Task Force (IETF) developed IPv6 Routing Protocol for LLNs (RPL). Based on routing metrics, such as hop count or expected transmission count (ETX), RPL builds a Directed Acyclic Graph (DAG) topology to establish bidirectional routes for LLNs. RPL routes are optimized for traffic to or from one or more roots that act as data sinks. A DAG is partitioned into one or more Destination Oriented DAGs (DODAGs), one DODAG per sink. Therefore, DODAG is basic logic structure in RPL. The traffic of LLNs flows along the edges of DODAG, either upwards to the root or downwards from the root. Upward routes, having the root as destination, are provided by the DODAG construction mechanism using the DODAG Information Object (DIO) messages. The root configures the DODAG parameters such as DODAG Version Number, DODAGID, and Root Rank and advertises these parameters in DIO messages. To join a DODAG, a node selects a set of DIO message senders as parents on the routes towards the root and computes its own rank. It also selects a preferred parent as next hop for upward traffic. Upon joining a DODAG, a node transmits the DIO messages to advertise the DODAG parameters. The Rank of the nodes must monotonically decrease as the DODAG Version is followed towards the DODAG root. Downward routes, from the root to other destinations, are provided by these destination nodes transmitting the Destination Advertisement Object (DAO) messages.

Some embodiments of the invention use RPL for load balanced routing in LLNs. For simplicity, some embodiments use one data sink to describe the load balanced method. However, load balanced method can be applied to other routing protocols and to LLNs with multiple data sinks.

In RPL, when establishing a DODAG for data collection, each node selects a set of parent nodes, referred as parent set, towards data sink. One of the members in the parent set is selected as preferred parent for upward data traffic. Depending on the routing metrics used, the selection of preferred parent may be different. Most commonly used routing metrics typically belong to a specific layer. For example, hop count indicates network layer distance, ETX represents the aggregated link layer communication quality, RSSI (Received Signal Strength Indicator) captures the physical layer signal quality for communication.

RPL does not consider load balancing. A node forwards all packets to its preferred parent. In practice, for load balanced packet routing, not only the channel condition should be considered, but also resource limitations of parents should be considered. Challenges for distributed load balanced routing are how to determine workload imbalance, and how to implicitly signal workload imbalance without increasing the communication overhead.

According to RPL, the root of a DODAG initiates DODAG formation process by transmitting the DIO message containing RPLInstanceID, DODAG identifier, DODAG version number, rank, and other parameters. After a node receives DIO messages, the node decides whether to join the DODAG or not. If the node decides to join the advertised DODAG, the node selects a subset of DIO message transmitters as its DIO parents and computes a rank value for itself. After joining DODAG, the node transmits a DIO message with Rank field set to its rank value. This process continues until DODAG formation is complete.

The DIO parents are potential next hop nodes for transmitting upward data to DODAG root. In RPL, only one parent, called the preferred parent, is used for upward data transmission. Other parents are used as backup parents.

For downward data transmission, a node selects a subset of DIO parents as its DAO parents and transmits DAO messages to DAO parents so that downward routes are discovered.

Workload Determination

In order to achieve load balanced routing, the nodes according to some embodiments determine their workload. It is impractical to globally calculate network-wide workload in large scale LLNs. Therefore, workload calculation is locally done in a distributed fashion such that each node determines its workload independently.

Several criteria can be used to calculate workload. For example, in some embodiments the node includes a memory having a buffer for storing the packets, and the processor of the node determines the workload based on a number of packets stored in the buffer. Packets queued include packets received by a node from its neighbor nodes for forwarding and packets generated by a node itself for transmission.

Other criteria for determining the workloads can also be used. For example, according to one embodiment, the average number of packets queued in buffer within a certain time period is defined as the workload of a node. According to another embodiment, the total number of packets that have been stored in the buffer within a certain time period is defined as workload of a node.

Non-Intrusive Workload Signaling

After a node determines its workload, the node signals to the neighboring nodes the extent of its workload so that the neighboring nodes can decide whether or not to forward their packets to the node. One way is to explicitly transmit a workload announcement packet or incorporate the workload explicitly in a packet to be transmitted. However, that method transmits more data and therefore increases overhead in network. The increased overhead increases the bandwidth, which must be minimized in LLN routing. The embodiments of the invention use an implicit way to signal workload, without transmitting the workload as a part of the content of the packets.

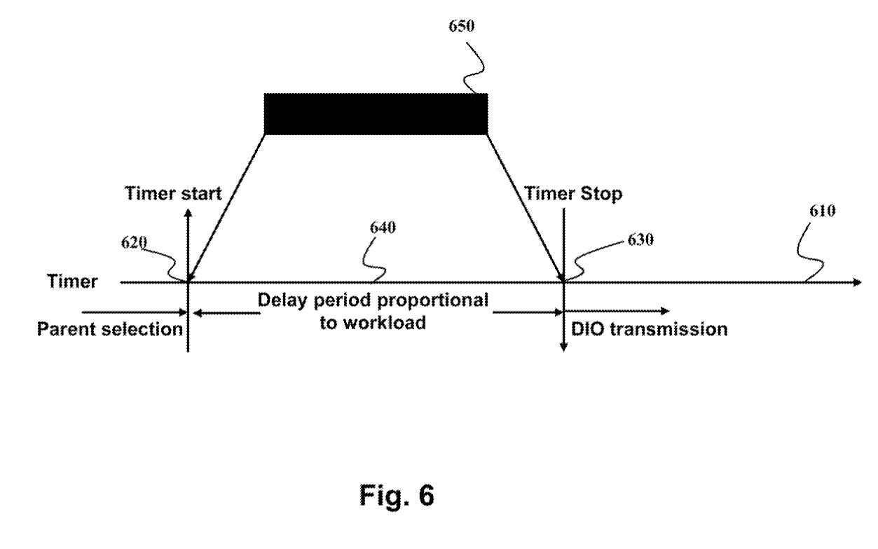

FIG. 6 shows a schematic of the method for indicating the workload of the node by delaying transmission of the packets. For example, after a node joins a DODAG, the node starts 620 a delay timer 610 with a delay period 640 proportional to its workload 650 such that the delay period is long when its workload is large and delay period is short if its workload is small. The delay length 640 can be determined by multiplying the workload 650 with a delay coefficient 285. For example, the workload can be determined in a number of packets and the delay coefficients can be in seconds. Thus, the product of the workload and the delay coefficient result in the delay period expressed in seconds. After a delay time expires 630, node starts DIO message transmission. Thus, in some embodiments, the node determines the workload, but instead of transmitting the workload explicitly and increasing the overhead of the network, the node delays a transmission of a packet proportionally to that workload to signal the workload implicitly.

For example, as shown in Equation (1), buffer storage limitation of a node significantly affects the probability of packet loss. In some embodiments, the workload is used in delay period calculation. With the workload, following is a method to calculate a delay timer value at a node i.

Tᵢ=T₀×Workload, (6)

where T₀ is a delay coefficient for the timer calculation. T₀ is used in a way such that back off delay of DIO message transmission does not affect delivery time of DIO message. That is, if two or more nodes start their DIO delay timers in about same time, then the DIO message with a longer delay must be received later than a DIO message with a shorter delay timer even though DIO message with shorter delay may have longer back off time than the DIO message with longer delay. This calculation results in a delay that is proportional to a workload of the node and can be used for signaling the workload.

Non-Intrusive Workload Detection

Some embodiments of the invention compare the workloads of next hop parent nodes. A node receives multiple copies of the DIO messages from its parent nodes. The node records the time at which it receives the DIO message from each parent. Depending on the time the DIO messages are received from these parent nodes, the node implicitly determines the workload of parents. An earlier time indicates a smaller workload and a later time indicates a larger workload. In some embodiments, the packets received by the node and used for determining the workloads include a route discovery packet, e.g., DIO, wherein the packets transmitted by the node include data packets.

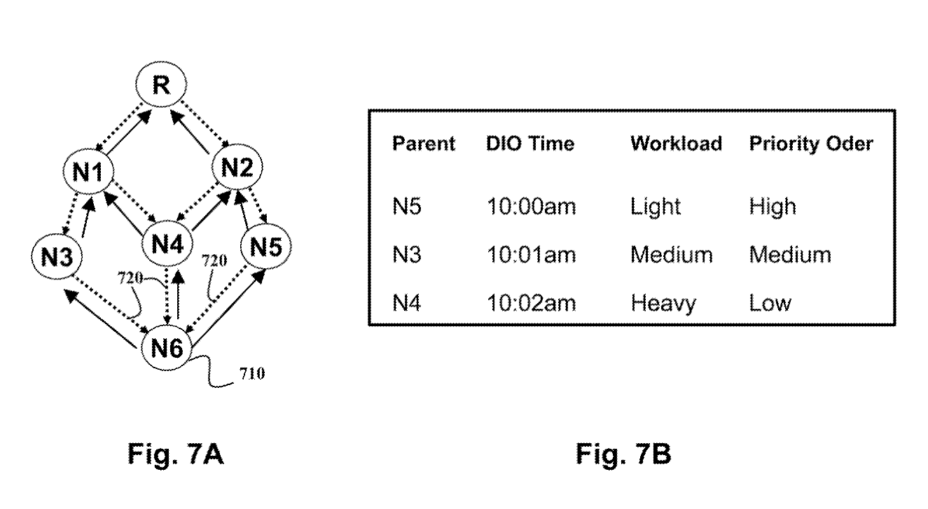

FIGS. 7A and 7B show the workloads allocation based on DIO receiving time. FIG. 7A shows that node N6 710 select three parents N3, N4 and N5 based on corresponding DIO messages 720. FIG. 7B shows that node N6 received DIO message from the node N5 at time 10:00 am, from the node N3 at 10:01 am and from the node N4 at 10:02 am. This time records indicate that the node N5 had small workload, node N3 had medium workload, and node N4 had large workload. Therefore, node N6 assigns a high priority to parent N5, a medium priority to parent N3, and a low priority to parent N4. As a result of priority assignment, the node N6 forwards its packets to its parents by distributing packets according to priority, for example, 50% of packets to parent N5, 30% of packets to parent N3 and 20% of packets to parent N4. In this way, more packets are forwarded to parent node with lower workload and fewer packets are forwarded to parent node with larger workload.

In some embodiments the comparison of workloads are determined for each time period. Parent selection and priority can vary over the time period. Even for the same parents, the priority can vary.

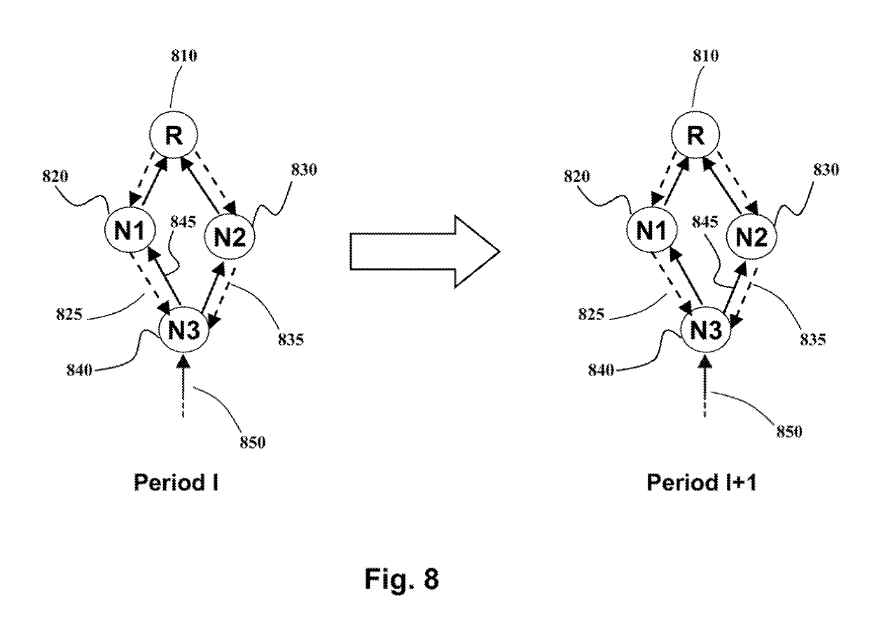

FIG. 8 shows an example of priority assignment variation at different periods, in which the nodes N1 820 and N2 830 received DIO message from the root node 810. Node N3 840 receives the DIO messages from nodes N1 and N2. Node N3 also has its children 850. In period I, upon receiving the DIO message from the root 810, N1 transmits its DIO message 825 without delay due to its small workload in period I−1. On the other hand, upon receiving DIO message from the root, node N2 delays the DIO message transmission 835 due to its large workload in period I−1. Therefore, upon receiving DIO messages from nodes N1 and N2, node N3 840 assigns node N1 a high priority order and assigns node N2 a low priority order. As a result, N3 forwards more packets 845 to node N1 in period I.

In period I+1, node N1 delayed its DIO message transmission due to its large workload in period I and node N2 did not delay its DIO message transmission due to small workload in period I. Therefore, in period I+1, node N3 assigns node N1 a low priority order and assigns node N2 a high priority order. Therefore, N3 forwards more packets 845 to node N2 and fewer packets to node N3 in period I+1.

Workload Based Route Discovery

According to RPL, the root of a DODAG acts as data sink and initiates DIO message transmission. The root transmits the DIO with new DODAG version periodically or non-periodically. Therefore, the DIO period may vary in length. A new DODAG version indicates a new DODAG formation. After a node receives DIO message with new version number, the node decides whether to join the new DODAG or not. The node re-selects parents and computes a rank value. The rank of a node can be computed according to routing metrics, such as the hop count distance to the root, or other metrics, according to RPL.

Different from RPL, to perform workload imbalance detection and signaling according to some embodiments of the invention, the node does not transmit a DIO with the new version number immediately. Instead, the node initializes a delay timer that is proportional to its workload in the previous period, and transmits the DIO message after the delay timer expires. This DIO transmission procedure continues at each increased level of the DODAG until the DIO message propagates to all nodes in network. This delay timer mechanism allows nodes with large workload to signal neighboring nodes the workloads in a previous period. As a result, nodes with large workload in previous period may have fewer children or have lower parent priority. Therefore, workload based route discovery balances workload among nodes.

Load Balanced Upward Data Forwarding

Unlike RPL, where a node forwards all its packets to its preferred parent, based on the parent priority, some embodiments of the invention select: k top priority parent nodes as potential next hop nodes for upward data forwarding. Moreover, link quality between a node and a parent is also used as parameter for upward data packets forwarding. The possibility of a node i forwarding data packet to a particular parent node j is calculated as

$${f}_{i j} = \frac{( 1 - {p}_{ij}^{c} ) \times {p}_{ij}^{f}}{{\sum }_{j}^{k} ( 1 - {p}_{ij}^{c} ) \times {p}_{ij}^{f}} \qquad ( 8 )$$

where pᵢⱼ^{c} is the packet loss probability due to channel condition between node i and node j, and pᵢⱼ^{f} is the priority factor defined as

$${p}_{ij}^{f} = \frac{{p}_{ij}^{o}}{{\sum }_{j}^{k} {p}_{ij}^{o}} \qquad ( 9 )$$

where pᵢⱼ^{o} is the priority. A higher priority has a larger value and a lower priority has a smaller value.

As a result, the packets forwarded by a node i are distributed among top k parent nodes based on both the pairwise link qualities and workload of parents. Moreover, when one of the parent nodes has a large workload during a current data collection period, that parent node increases the delay in DIO message transmission in the next period, and may result in a priority that is not in the top k in the parent table of the child node. As a result, this node is not be used as next hop for data forwarding. Hence, workload imbalance can be reduced. For example, in FIG. 7A, if node N6 selects top 2 (k=2) parents, node N6 will not forward packets to parent node N4.

In equation (8), the value of k depends on the applications, network environment and other factors. The priority pᵢⱼ^{c} can be dynamically obtained using information of successful or failed network-layer transmissions via a media access control (MAC) layer feedback mechanism. For example, in networks according to the IEEE 802.11 standard, after successfully receiving a unicast packet at the MAC layer, the receiver will reply with an acknowledgement packet to the MAC layer of the sender. The MAC layer of the sender sends this information to network routing layer. Hence, the sender knows the transmission was successful. If the sender does not receive the acknowledgement and the transmission reaches the maximum retry limit specified by the IEEE 802.11 MAC layer protocol, then the MAC layer failure is reported to the network layer.

To acquire short-term wireless channel variation, the reachability of top k priority parent nodes can be verified dynamically. After a top k parent node is detected unreachable, this parent node is not used as the next hop node. In this case, the top k−1 parent nodes can be used as next hop nodes or another parent node can be selected to replace the unreachable parent node. However, such unreachable parent node can be reused as next hop node when the node becomes reachable.

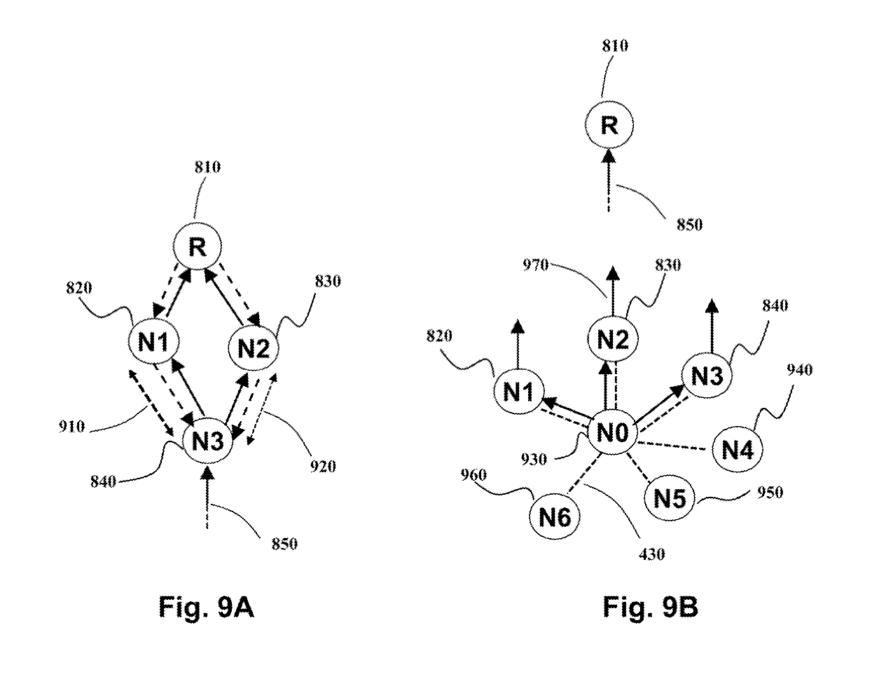

FIG. 9A shows an example of load balanced upward data forwarding, in which node N3 has two parent nodes N1 and N2. Node N signaled a small workload by using a short DIO message delay time and node N2 signaled a large workload by using a long DIO message delay time. Also, node N3 detects a better link quality 910 to node N1 than a link quality 920 to node N2. Therefore, node N3 forwards more its packets to node N1 and fewer packets to node N2 to achieve load balance.

FIG. 9B shows an example of parent selection and load balanced upward data forwarding, in which based on wireless link 430, node NO 930 has six neighbors N1 820, N2 830, N3 840, N4 940, N5 950 and N6 960. NO selects three neighbors N1, N2 and N3 as its parent nodes. Therefore, node NO forwards its packets to three parent nodes to achieve load balance.

Two methods below provide examples for implementing load balanced upward data forwarding.

Method 1: Node Initialization Procedure

1: Initialize parent set and buffer utilization counter
2: Update latest received DODAG version number
3: Insert selected DIO message sources to parent set according to the message arrival time
4: Calculate rank value
5: Set timer value Tᵢ according to Equation (6)
6: Generate a DIO message with its own rank number and the latest DODAG version number
7: When time Tᵢ expires, broadcast a DIO packet with current rank and DODAG version number

Method 2: Load Balanced Routing for RPL

1: A node listens to the radio channel
2: Once a message M arrives, check the type of the message
3: if M is a DIO message then
4: if New version of DIO then

### 5: Invoke Sensor Node Initialization Procedure

6: else
7: if Current DIO version then
8: if Rank value carried in the message is less than current node's rank then
9: Insert the DIO message source to parent set according to message arrival time
10: end if
11: else
12: Discard this message
13: end if
14: end if
15: else
16: if M is a DAO message then
17: Process it according to RPL
18: end if
19: else
20: if M is data message then
21: Update buffer utilization counter
22: Forward this message by choosing the first k parent nodes from parent table, and selecting one as next hop with probability Equation (8)
23: end if
24: end if

Load Balanced Downward Data Forwarding

According to RPL, downward routing depends on a mode of operations. In storing mode, each router node stores downward routes to the nodes in its sub-DODAG. In non-storing mode, the root stores downward routes to all nodes. DODAG structure allows multipath routing. Therefore, multiple downward routes to a destination node are also possible, and load balanced downward data forwarding can be necessary.

To achieve load balanced downward data routing, a node records the number of upward data packets the node receives from each of child nodes in a current period. If there are multiple downward routes to a destination, then the forwarding node distributes downward packets to its children on the multiple routes based on the upward workload records of the children. The forwarding node sends more downward packets to a child with smaller upward workload and fewer downward packets to a child with a larger upward workload. The forwarding node can be any router node in storing mode and is the root only in non-storing mode.

Accordingly, in one embodiment, the node, e.g., the processor of the node, determines the ratio of the transmitted packets based on a number of packets received from the children nodes. In another embodiment, the processor updates the ratio of the transmitted packets based on a number of packets received from the first and the second nodes.

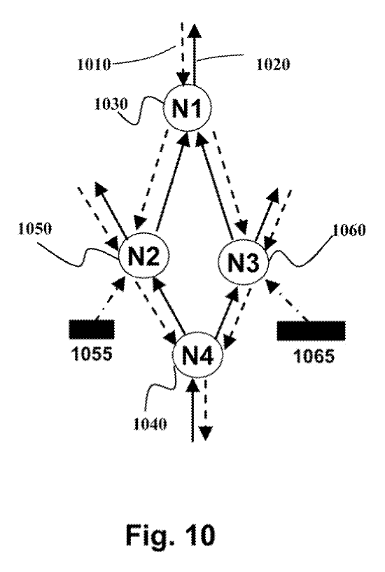

FIG. 10 shows an example of load balanced downward data routing 1010, as contrasted with upward data routing 1020. The node N1 1030 transmits downward packets destined to node N4 1040. Node 1 forwards more downward packets to node N2 1050 and fewer packets to node N3 1060, because upward workload 1055 of the node N2 is smaller than upward workload 1065 of the N3.

Performance Comparison

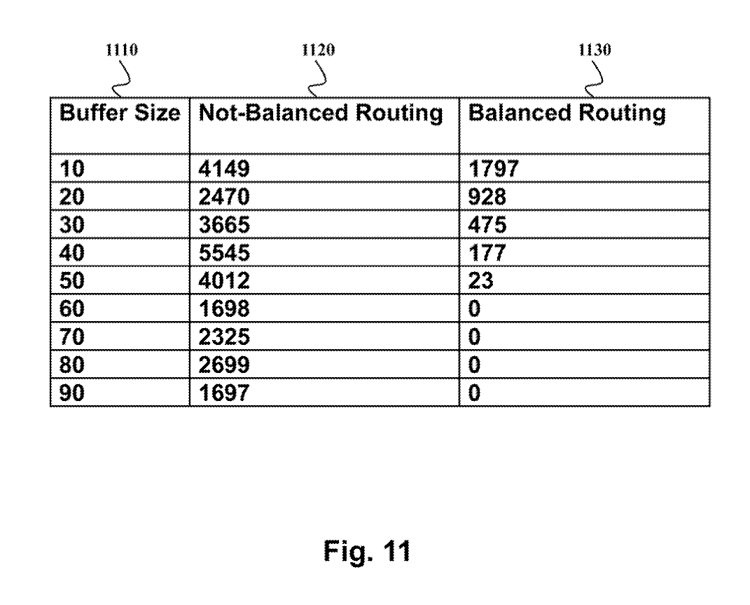

FIG. 11 shows a table illustrating a number of lost packets based on buffer size 1110 in LLN nodes. When the buffer size at each node is smaller, more packets are lost due to buffer limitation. However, nodes using non-balanced routing method 1120 lose much more packets. When buffer is larger, the nodes using balanced routing 1130 do not loose packets.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format. The processor can be connected to memory, transceiver, and input/output interfaces as known in the art.

Also, the various methods or processes outlined herein may be coded as software that is executable on one or more processors that employ any one of a variety of operating systems or platforms. Alternatively or additionally, the invention may be embodied as a computer readable medium other than a computer-readable storage medium, such as signals.

The terms “program” or “software” are used herein in a generic sense to refer to any type of computer code or set of computer-executable instructions that can be employed to program a computer or other processor to implement various aspects of the present invention as discussed above.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A node, comprising:
a receiver for receiving a first packet from a first node at a first time and a second packet from a second node at a second time;
a processor for determining the first time and the second time and for comparing the first time with the second time to produce a ratio of workloads of the first node and the second node; and
a transmitter for transmitting packets to the first and the second nodes based on the ratio of workloads.

2. The node of claim 1, wherein the first packet and the second packet include a route discovery packet, wherein the transmitted packets include data packets, and wherein the first time is earlier than the second time, such that data packets transmitted to the first node are transmitted more often than data packets transmitted to the second node.

3. The node of claim 1, wherein the processor determines a ratio of the packets transmitted to the first and the second nodes based on the ratio of the workloads.

4. The node of claim 3, wherein the processor updates the ratio of the transmitted packets based on quality of links connecting the node with the first node and with the second node.

5. The node of claim 3, wherein the processor updates the ratio of the transmitted packets based on a number of packets received from the first and the second nodes.

6. The node of claim 1, wherein the processor determines a number of packets Z₁ for transmitting to the first node according to
Z₁=(T₂/(T₁+T₂))*Z,
wherein the processor determines a number of packets Z₂ for transmitting to the second node according to
Z₂=(T₁/((T₁+T₂))*Z,
wherein T₁ is the first time, T₂ is the second time, and Z is a total number of the packets transmitted to the first and the second nodes.

7. The node of claim 1, wherein the processor determines a workload of the node, the node further comprising:
a timer operatively connected to the processor and to the transmitter for delaying the transmitting of a route discovery packet based on the workload.

8. The node of claim 7, wherein the processor multiplies the workload of the node with a delay coefficient to determine an extent of the delaying.

9. The node of claim 8, wherein the processor updates the delay coefficient during an operation of the node.

10. The node of claim 7, further comprising:
a memory having a buffer for storing the packets, wherein the processor determines the workload based on a number of packets stored in the buffer.

11. The node of claim 10, wherein the processor multiplies the number of packets with a delay coefficient to determine an extent of the delaying.

12. The node of claim 1, wherein the node, the first node and the second node form a part of a low-power and lossy network.

13. A method for routing packets by a node in a low-power and lossy network, comprising:
determining a first node having a workload less than a workload of a second node based on packets received from the first and the second nodes; and
generating a command to transmit a set of data packets to the first and the second nodes, such that more packets from the set are transmitted to the first node than to the second node, wherein steps of the method are performed by a processor of the node.

14. The method of claim 13, wherein the determining comprises:
comparing a first time of receiving a route discovery packet from the first node with a second time of receiving a route discovery packet from the second node.

15. The method of claim 14, further comprising:
determining a number of packets Z scheduled for transmission;
determining a number of packets Z₁ for transmitting to the first node according to
Z₁=(T₂/(T₁+T₂))*Z;and
determining a number of packets Z₂ for transmitting to the second node according to
Z₂=(T₁/(T₁+T₂))*Z,
wherein T₁ is the first time, T₂ is the second time.

16. The method of claim 13, wherein the determining comprises:
comparing a number of packets received from the first node with a number of packets received from the second node.

17. The method of claim 14, further comprising:
multiplying the workload with a delay coefficient to determine the delay.

18. A node, comprising:
a receiver for receiving route discovery packets from neighboring nodes;
a processor for comparing workloads of the neighboring nodes in response to the receiving to produce a ratio of workloads; and
a transmitter for transmitting data packets to the neighboring nodes according to the ratio.

19. The node of claim 18, wherein the processor determines the workloads independently from the neighboring nodes based on times of the receiving the route discovery packets.
